(19) United States
(12) Patent Application Publication
(10) Pub. No.: US 2004/0130525 A1
(43) Pub. Date: Jul. 8, 2004

(54) Dynamic touch screen amusement game controller

(76) Inventor: Edward J. Suchocki, Buffalo Grove, IL (US)

Correspondence Address: JENKENS & GILCHRIST, P.C., 225 WEST WASHINGTON, SUITE 2600, CHICAGO, IL, 60606, US

(21) Appl. No.: 10/716,334

(22) Filed: Nov. 18, 2003

Related U.S. Application Data
(60) Provisional application No. 60/427,580, filed on Nov. 19, 2002.

(51) Int. Cl. G09G 5/00

(52) U.S. Cl. 345/156

(57) ABSTRACT

A game device includes a presentation medium and a dynamic control area displayed on the presentation medium. The dynamic control area is a two-dimensional video representation of a three-dimensional player control interface. The dynamic control area allows the simulation of three-dimensional controllers using a touch screen interface, thereby allowing velocity and directional information to be input using a touch screen. Interaction with a amusement game under the present invention may involve interaction solely with the dynamic control area rather than the use of specialized controllers provided on the game device.

### CROSS-REFERENCE TO RELATED APPLICATION

This application claims the benefit of priority of U.S. Provisional Patent Application Serial No. 60/427,580, filed Nov. 19, 2002.

### FIELD OF THE INVENTION

The present invention relates generally to amusement games and, more particularly, to a touch screen control system for amusement games.

### BACKGROUND OF THE INVENTION

Amusement games have used a variety of input devices to control on-screen characters or actions. These devices include hand-held controllers such as joysticks and steering wheels, push buttons, foot pedals, and touch screens. Traditionally, touch screens have been used for static action selections in amusement games. For example, one popular use of a touch screen in an amusement game is to enable the selection of an option by a game player among several different options. In this respect, touch screens have been used very similarly to push buttons.

There is an increasing desire to reduce the size of amusement games and further to increase the appeal of amusement games to players. The use of tabletop game units has been one development in reducing the size of amusement games such as arcade games. Tabletop game units may be found, for example, on bars or restaurant tables and often involve some form of touch screen input by the user. Traditionally, these tabletop game units have played games such as trivia games and memory games, requiring the use of the touch screen input to select individual items. Because of the common limitation to more static selections, tabletop game units have not traditionally received continuous or dynamic inputs such as the inputs required to play more involved arcade games such as fighting games, sports games, driving games, and the like. Further, touch screen games have not simulated the action of familiar or specialized game controls that are more popular with game players. It is believed that the incorporation of a more dynamic control input mechanism into touch screen based games would increase the attractiveness of touch screen games to players.

### SUMMARY OF THE INVENTION

In one embodiment of the present invention, there is provided a game device comprising a presentation medium having a touch screen control mechanism. The touch screen control mechanism includes a dynamic touch screen area adapted to accept dynamic or continuous touch inputs.

In one embodiment of the present invention, the dynamic touch screen area is designed to resemble an amusement game joystick in appearance and operation. The amusement game joystick may be a traditional joystick or a joystick biased in a predetermined direction other than the center, such that the biased joystick tends to return to a particular point after being operated by touching.

In another embodiment of the present invention, the dynamic touch screen area is designed to resemble a track ball controller, both in appearance and in operation. In this embodiment, as with a traditional track ball, the speed with which a player moves his hand over the active touch screen area affects the speed at which the simulated track ball moves and, in turn, this affects the on-screen behavior resulting from controller motion.

The above summary of the present invention is not intended to represent each embodiment, or every aspect, of the present invention. This is the purpose of the figures and the detailed description which follow.

### BRIEF DESCRIPTION OF THE DRAWINGS

The foregoing and other advantages of the invention will become apparent upon reading the following detailed description and upon reference to the drawings.

FIG. 1 is a perspective view of an amusement game device embodying the present invention.

FIG. 2 is a diagram of a dynamic control area simulating a biased joystick for use with an amusement game device.

FIG. 3a is a diagram of a dynamic control area simulating a standard joystick for use with a game device.

FIG. 3b is a diagram of a the dynamic control area of FIG. 3a after being acted upon by a player.

FIG. 4 is a diagram of a dynamic control area simulating a track ball controller for use with a game device.

FIG. 5 is a block diagram showing the flow of data in an amusement game device according to the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF SPECIFIC EMBODIMENTS

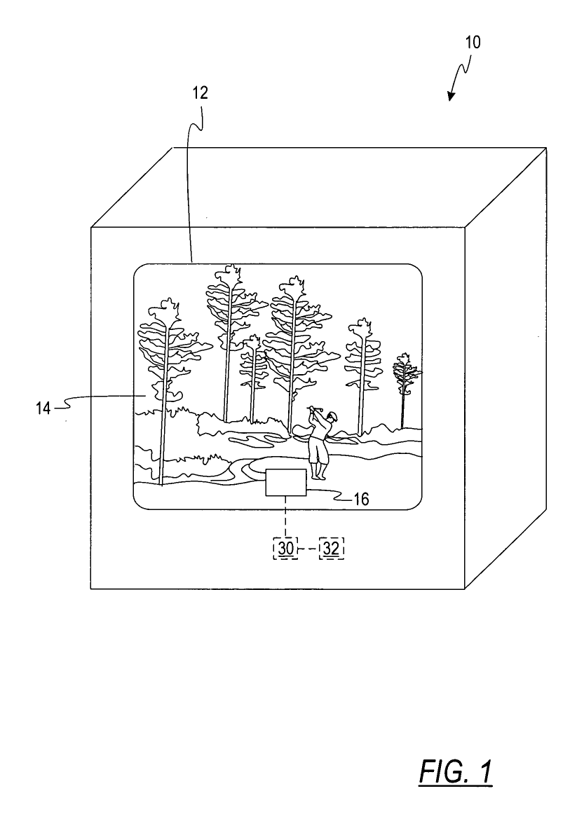

Turning now to the drawings and referring initially to FIG. 1, there is depicted an amusement game device 10 that may be used to implement a game according to the present invention. The amusement game device 10 includes a presentation medium 12 having a touch screen interface 14. In one embodiment, the presentation medium 12 is a video monitor, such as a CRT monitor or an LCD monitor. The touch screen interface 14 on the presentation medium 12 may cover the entire presentation medium, or it may cover only a portion of the presentation medium 12. At least a portion of the touch screen interface 14 covers at least a portion of a dynamic control area 16. The dynamic control area 16 may be the only portion of the presentation medium 12 capable of taking touch screen input, or it may be a subsection of a larger touch screen interface 14. In one embodiment, the dynamic control area 16 may take up the entire presentation medium 12. In embodiments where the dynamic control area 16 does not take up the entire presentation medium 12, it may be positioned anywhere on the presentation medium 12. In an alternative embodiment, it is possible to provide a second, separate presentation medium on which the dynamic control area 16 is implemented. In one embodiment, the dynamic control area 16 depicts the main control interface used by a player playing a game on the amusement game device 10. The dynamic control area 16 includes an updateable video depiction of an amusement game control interface. The dynamic control area 16 reacts to dynamic touch controls from a user, such as dragging motions from a finger or hand upon the portion of the touch screen interface 14 overlaying the dynamic control area 16, to simulate an amusement game control interface. In one embodiment, the dynamic control area 16 includes an animated control image which is a portion of a larger image depicted on the presentation medium 12. Amusement game control interfaces capable of being simulated by the controller of this invention include trackballs, joysticks, biased spring-loaded game controllers, turn knobs, D-pads (such as found in console game controllers), steering wheels, handlebars, pinball plungers, or any other types of mechanical control devices.

The amusement game device 10 may have a variety of formats. In one embodiment, the amusement game device 10 is a specialized game device adapted to play a single amusement game. In another embodiment, the amusement game device 10 is a multiple-game amusement game device adapted to play a variety of different games, which may be from the same genre or from various game genres. Though specific game types will be used to show the operation of the present invention, it is to be understood that in both the single-game and multiple game embodiments, the amusement game device 10 may be adapted to play any game capable of display on the presentation medium 12. The video-based controller of the present invention allows a multitude of different game play styles using one input device.

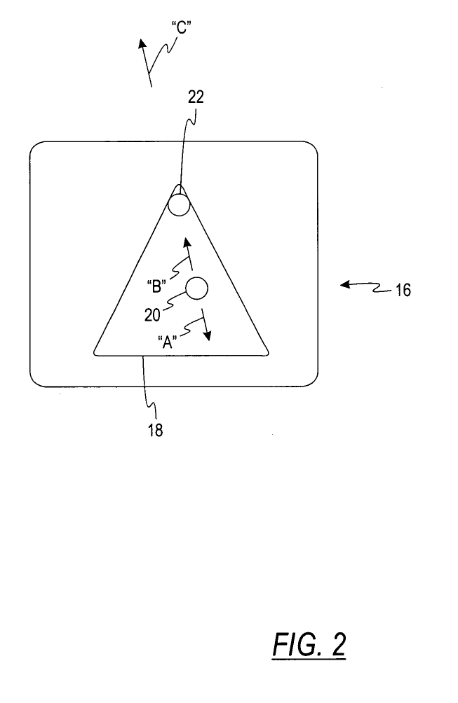

FIG. 2 is a diagram demonstrating the design and operation of a dynamic control area 16 according to one embodiment of the present invention. The dynamic control area 16 shown in FIG. 2 contains a biased joystick control region 18. The biased joystick control region 18 shown in FIG. 2 is triangular in shape. Other shapes, such as a circular shape, an oval or elliptical shape, or other polyhedron shapes may also be useful. Though the dynamic control area 16 is shown to be larger than the biased joystick control region 18, both regions may be the same size, so that the biased joystick control region 18 and the dynamic control area 16 may be the same. The biased joystick control region 18 contains a simulated biased joystick 20. The simulated biased joystick 20 moves in response to a player's “dragging” the simulated biased joystick 20 by pressing down on the image of the simulated biased joystick 20 and pulling the simulated biased joystick 20 around the biased joystick control region 18, with the position of the finger being constantly detected by the touch screen interface 14. If the player should attempt to drag the simulated biased joystick 20 outside the biased joystick control region 18, the simulated biased joystick 20 may remain at its last position or it may follow to a position closest to where the player is attempting to drag the simulated biased joystick 20.

The simulated biased joystick 20 is programmed to behave such that, following any movement away from a corner 22 of the biased joystick control region 18, the simulated biased joystick 20 tends to move back into the corner 22. The corner 22 shown in FIG. 2 is an upper corner, though it is to be understood that another corner or even another non-central location could be chosen for the simulated biased joystick's return position. For example, if the simulated biased joystick 20 is pulled in the direction indicated by the arrow “A,” it will have a tendency to return in the direction indicated by the arrow “B.” In one embodiment, the relevant control input into a game will be in the direction of arrow “B,” as shown by arrow “C.” The simulated biased joystick 20 is useful in sports games such as golf games, where the movement described above would, at least initially, send a ball in the direction of arrow “C.” In addition, the further the simulated biased joystick 20 is pulled, from the corner 22, the greater the velocity that may be input into the amusement game device 10. The simulated biased joystick 20 may be used in any game where a single directional and velocity input is required from time to time. For example, baseball swings, football passes or kicks, or boxing punches might all be controlled using the simulated biased joystick 20.

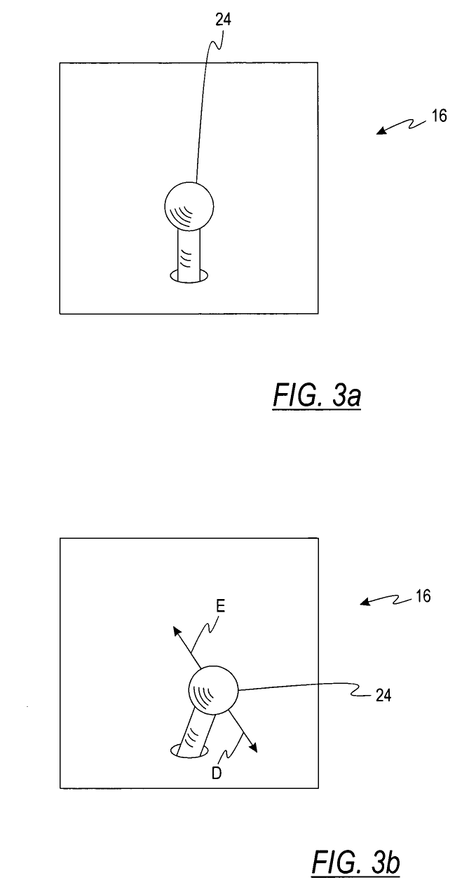

Turning now to FIGS. 3a and 3b, an alternative embodiment for a dynamic control area 16 is shown. The dynamic control area 16 of FIGS. 3a and 3b includes a simulated standard joystick 24. Similarly to joysticks known in the amusement game industry, the simulated standard joystick 24 will tend to return to the central position shown in FIG. 3a if it is moved away from the central position. As shown in FIG. 3b, if the simulated standard joystick 24 is pulled in the direction shown by arrow “D,” it will tend to return to a central position as shown by arrow “E” when it is released. As with the simulated biased joystick 20 of FIG. 2, the simulated standard joystick 24 may be dragged within a certain range. In one embodiment, the simulated standard joystick 24 may be dragged within a range approximating the range of a standard amusement game joystick. Thus, the simulated standard joystick 24 reduces a standard three-dimensional joystick as found in many arcade games into a two-dimensional representation designed to mimic the behavior of a standard three-dimensional joystick. The use of a dynamic control area 16 thus allows the approximation of standard amusement game controls in situations where standard amusement game controls may not be practical. Such a situation may be encountered on the type of amusement game device 10 shown in FIG. 1, which is a table-top amusement game device 10 not having the standard control layout that might be found in a more traditional stand-up arcade game.

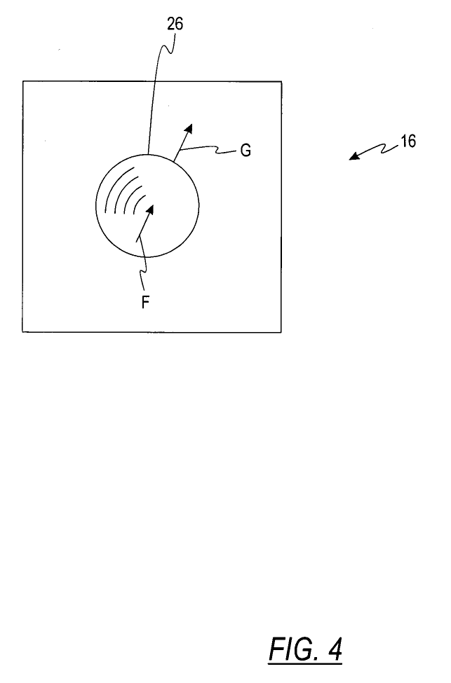

Turning now to FIG. 4, another alternative embodiment for a dynamic control area 16 is shown. In the embodiment of FIG. 4, the dynamic control area 16 includes a representation of a simulated track ball 26. A track ball is a known amusement game control device which allows directional and velocity information to be input into a amusement game by a player. Track balls slow down due to friction after being acted upon. According to one embodiment of the present invention, an alterable apparent friction is associated with the simulated track ball 26. In the embodiment shown in FIG. 4, the simulated track ball 26 is moved in a direction indicated by the arrow “F.” This is accomplished by a player dragging his finger or pushing with his hand in the direction indicated by the arrow “F.” The resulting input into the amusement game device 10 is also in the direction of arrow “F,” as shown by the arrow “G.” The faster the simulated track ball 26 is moved, the greater a velocity component of input into the amusement game device 10 will be.

The simulated track ball 26 may be used in any game where a standard track ball would be used. For example, in a golf game, the simulated track ball 26 might be pushed with great speed during a drive or fairway shot and operated with more finesse in a chip or putt situation. This is similar to the use of the simulated biased joystick 20, which may be pulled farther to impart more force to a ball during a drive or fairway shot, and pulled only a short distance to accomplish a closer putt or chip shot.

The present invention allows the input of control information with directional and velocity components into an amusement game device 10. For example, in the embodiment of FIGS. 3a and 3b, using a simulated standard joystick 24, the amusement game device 10 may react not only to the directional information showing where the simulated standard joystick 24 is positioned, but it may also react to the speed with which the simulated standard joystick 24 is moved from one position to another.

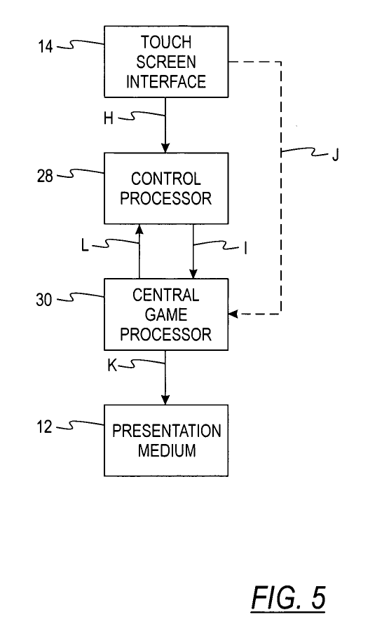

Turning now to FIG. 5, the interaction of a dynamic control area 16 according to one embodiment of the present invention with other components of an amusement game device 10 is shown. A player acts upon the touch screen interface 14, for example by dragging or pushing on the touch screen interface 14, as discussed above. The touch screen interface 14 sends control-related signals to a control processor 28 as shown by arrow “H.” The control processor 28 may be a separate microprocessor designed to carry out control-related instructions. Alternatively, the functions of the control processor 28 may be carried out by a central game processor 30. Data flowing from the touch screen interface 14 to the control processor 28 may include data on the position and velocity of input from the player.

The control processor 28, whether it is an independent control processor or its functions are performed by a central game processor 30, also serves to route and interpret control information so that the amusement game device 10 reacts properly to player inputs. According to one embodiment, control information is sent from the control processor 28 to a central game processor 30 as shown by arrow “I.” Alternatively, information from the touch screen interface 14 may be routed directly to the central game processor 30 as shown by the dotted line “J.”

The control information may be interpreted and routed in a variety of ways by either the control processor 28 or the central game processor 30. For example, when a player-touches a location within the dynamic control area 16, a processor may determine whether the location touched corresponds to the location of a simulated control object, such as the simulated standard joystick 24 of FIG. 3a. When such a touch is turned into a drag, the resulting control information informs a processor that the player is moving the simulated standard joystick 24. In response, the presentation medium 12 may be updated to show a different location for the simulated standard joystick 24 and also to show the result of this movement on the game.

The central game processor 30 receives the control information and reacts to it by updating the presentation medium 12 as shown by arrow “K” to show the results of the control input. This updating of the presentation medium includes an update of the information within the dynamic control area 16 as well as an update of gameplay graphics which show the in-game results of a player's control. As is well known in the interactive game arts, a number of processor tasks, such as control and video processing, may be divided among several dedicated processors or consolidated within only a few processors, or even one central processor. Thus, in one embodiment, the updating of the presentation medium 12 may be accomplished through the use of a separate video processor. The central game processor 30 also updates the status of the game that is being played to reflect changes due to the control inputs. The central game processor 30 may route information relating to control back to the control processor 28, as shown by arrow “L.” This information may include an update that the central game processor 30 is ready to accept new control input.

According to one embodiment, the presentation medium 12 is updated with information pertaining to the function of the simulated controller within the dynamic control area 16. In the simulated biased joystick embodiment shown in FIG. 2, the presentation medium 12 may be updated with information which instructs the simulated biased joystick 20 to return to the corner 22 once the simulated biased joystick 20 has been released by the player. Similarly, in the simulated standard joystick embodiment shown in FIGS. 3a and 3b, the presentation medium 12 may be updated to instruct the simulated standard joystick 24 to return to a central position after being acted upon by the player. Further, in the simulated track ball embodiment shown in FIG. 4, the presentation medium 12 may be updated with information which instructs the simulated track ball 26 to gradually slow down after being acted upon by the player.

In general, either the central game processor 30 or a separate video processor instructs the presentation medium 12 to display an image such that the visual representation of a controller within the dynamic control area 16 mimics the behavior, in terms of responsiveness and appearance, of a true, three-dimensional controller. Thus, a player of a system according to the presentation medium will receive at least two visual indicia of his actions, one being the behavior of a simulated controller and the other being the results of his controls in the game itself.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. An amusement game device comprising:
a presentation medium providing a visual depiction of a game;
a touch screen interface overlaid upon the presentation medium; and
a dynamic control area depicted by the presentation medium, the dynamic control area reacting to dynamic touch inputs from a user into the touch screen interface and containing a visual representation of a control interface.

2. The amusement game device of claim 1 wherein the dynamic control area contains a representation of a biased joystick having a tendency to return to a predetermined location following a dynamic touch input.

3. The amusement game device of claim 2 wherein the biased joystick is contained within a biased joystick control region and the predetermined location is a corner of the biased joystick control region.

4. The amusement game device of claim 3 wherein the biased joystick control region is triangular and the corner is an upper corner of the triangular biased joystick control region.

5. The amusement game device of claim 1 wherein the dynamic control area contains a representation of a standard joystick having a tendency to return to a central location following a dynamic touch input.

6. The amusement game device of claim 1 wherein the dynamic control area contains a representation of a track ball.

7. The amusement game device of claim 6 wherein the track ball has an alterable apparent friction associated therewith.

8. A method for processing control information in an amusement game device comprising:
providing a dynamic control area on a presentation medium, the dynamic control area having a video representation of a control interface;
accepting a dynamic touch control on a touch screen interface overlaying the dynamic control area; and
presenting the results of the dynamic touch control.

9. The method of claim 8 further comprising updating the video representation of the control interface in response to the dynamic touch control.

10. The method of claim 9 further comprising returning the video representation of the control interface to an initial state following the termination of the dynamic touch control.

11. The method of claim 8 wherein the video representation of the control interface is a video representation of a biased joystick interface.

12. The method of claim 8 wherein the video representation of the control interface is a video representation of a standard joystick interface.

13. The method of claim 8 wherein the video representation of the control interface is a video representation of a track ball interface.

14. The method of claim 8 wherein the dynamic touch control is a dragging motion on the dynamic control area.

15. A dynamic control area for an amusement game device comprising:
a touch screen interface adapted to accept a dynamic touch control; and
an animated simulation of a control interface contained within the dynamic control area, the animated simulation being adapted to visibly move in response to the dynamic touch control.

16. The dynamic control area of claim 15 wherein the animated simulation of the control interface is an animated simulation of a biased joystick.

17. The dynamic control area of claim 15 wherein the animated simulation of the control interface is an animated simulation of a standard joystick.

18. The dynamic control area of claim 15 wherein the animated simulation of the control interface is an animated simulation of a track ball.

19. An amusement game device comprising:
a presentation medium;
a touch screen interface overlaying the presentation medium, at least a portion of the touch screen interface overlaying a dynamic control area having an animated representation of a control interface;
a control processor connected to the touch screen interface; and
a central game processor connected to the control processor.

20. The amusement game device of claim 19 wherein the animated representation of the control interface is a representation of a biased joystick.

21. The amusement game device of claim 19 wherein the animated representation of the control interface is a representation of a standard joystick.

22. The amusement game device of claim 19 wherein the animated representation of the control interface is a representation of a track ball.

23. The amusement game device of claim 19 wherein the control processor is adapted to process inputs from the dynamic control area and is further adapted to forward control behavior information to the dynamic control area.

24. The amusement game device of claim 19 wherein the control behavior information includes information controlling the animated representation of the control interface.

25. The amusement game device of claim 19 wherein the dynamic control area is adapted to accept inputs from a player, the inputs having directional and velocity components.

26. An amusement game device comprising:
a presentation medium having a dynamic control area depicted thereon, said dynamic control area depicting an image of a simulated joystick;
a touch screen interface overlaying the dynamic control area, the touch screen interface accepting touch inputs and generating control signals corresponding to said touch inputs; and
a processor accepting the control signals and generating position update signals enabling the dynamic control area to graphically depict movement of said simulated joystick.
